(19) United States
(12) Patent Application Publication
(10) Pub. No.: US 2016/0278588 A1
(43) Pub. Date: Sep. 29, 2016

(54) BATHING AID TRAVEL AND DRYING DEVICE

(71) Applicants: James W. Caldwell, Humble, TX (US); Patrick E. Caldwell, Nagoya (JP)

(72) Inventors: James W. Caldwell, Humble, TX (US); Patrick E. Caldwell, Nagoya (JP)

(21) Appl. No.: 14/667,674

(22) Filed: Mar. 24, 2015

(51) Int. Cl. A47K 17/00; B65D 8/00; B30B 9/26; B65D 25/02

(52) U.S. Cl. CPC A47K 17/00; B65D 25/02; B65D 11/02; B30B 9/26

(57) ABSTRACT

A bathing aid storage device comprises a first shell, a second shell, and a drain hole. At least one of the first shell and the second shell comprises a plurality of apertures. At least one of the first shell and the second shell comprises a plurality of gullies. The first shell and the second shell define an enclosure, the enclosure being configured to accommodate a bathing aid.

### TECHNICAL FIELD

The present invention relates generally to the field of personal hygiene and, more particularly, to a bathing aid travel and drying device.

### BACKGROUND

Modern personal fitness activities have become increasingly popular and effective, even as unstructured free time becomes more difficult to obtain. Designated exercise areas such as gyms and fitness centers have become a convenient location for both exercise and the subsequent personal hygiene maintenance necessary to return to ordinary activities, especially work and socialization. Many designated exercise areas therefore include bathing or showering facilities, especially those facilities used by workers during their lunch break, for example.

Simultaneously, developments in personal hygiene have given rise to improved bathing aids. In particular, a bathing aid sometimes called a “loofah” has become a popular replacement for the standard washcloth. Generally, a loofah is a sponge-type product that many people use as a washcloth-type device for bathing and/or showering. A “natural” or “organic” loofah is sponge-type product manufactured from a naturally-occurring or farm-raised plant, typically Luffa aegyptiaca or Luffa acuangula, and typically comprises the desiccated and processed fruit of the plant. A synthetic loofah serves the same purpose, but is manmade and is typically formed into a rough sphere from woven plastic or other synthetic fabric. Generally, a synthetic loofah is less expensive than a natural or organic loofah. Both natural and synthetic loofahs are effective bathing aids and have become especially popular with home-users, as well as travelers and users of designated exercise areas.

However, with the increase in loofah usage, some problems have become apparent. For example, the loofah user away from home generally does not have anywhere to put the loofah after use so that it may dry in a ventilated environment while protected from the elements. Additionally, while a typical loofah can be wrung out to remove some of the moisture, many loofahs retain a significant amount of moisture and require some time to dry. It is well known that dampness without sufficient aeration can lead to mildew, unpleasant odors, bacteria, or other undesirable consequences. At the same time, it is usually inconvenient for the loofah user to simply hold the loofah while waiting for it to dry.

As such, loofah users sometimes elect to place the damp or wet loofah in a gym bag, for example. But simply placing a damp or wet loofah in the same container as the user's gym clothes, towel, etc., leads to several problems. For example, placing the damp/wet loofah in a gym bag or backpack allows the loofah to come into contact with other contents that may be unclean or contain bacteria. This also transfers moisture to the other contents, spreading the potential for mold, mildew, bacteria, and other undesirable conditions.

Often, a loofah user will simply wrap the loofah in a bath towel, essentially using the towel to absorb the excess moisture. In some cases, the towel can wick away moisture from the loofah and the relatively larger surface area of the towel can expedite moisture removal. In some cases, particularly when the towel is also damp, placing the wet/damp loofah in the towel mostly just confines the moisture to the towel. This can be effective at preventing moisture from spreading further when the towel and loofah are placed inside a gym bag or other travel bag. However, this approach tends to exacerbate problems with aeration and can result in increased problems with mildew, odor, etc.

In some cases, the loofah user will carry a plastic bag to store the loofah after use, to prevent dispersion of excess moisture and reduce the problems associated with storing a damp loofah. These approaches tend to restrict the problem to the confines of the plastic bag. However, wet/damp loofahs are frequently put in plastic bags that do not ventilate and therefore can increase the generation of mildew/odor/etc. In some cases, the exacerbated problems can outweigh the benefits of restricting the problems to the plastic bag. For example, in some cases, the same storage bag is used to hold the loofah in between uses, building up more and more mildew and bacteria with each use, despite the marginal cleaning that comes from using the loofah with soap while bathing.

Therefore, there is a need for a bathing aid system and/or method that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A bathing aid storage device comprises a first shell, a second shell, and a drain hole. At least one of the first shell and the second shell comprises a plurality of apertures. At least one of the first shell and the second shell comprises a plurality of gullies. The first shell and the second shell define an enclosure, the enclosure being configured to accommodate a bathing aid.

In one embodiment, the first shell defines a first section of the drain hole and the second shell defines a second section of the drain hole.

In one embodiment, the device further comprises a closing mechanism coupled to the first shell and the second shell. In one embodiment, the closing mechanism comprises a snap.

In one embodiment, the enclosure further comprises a closed configuration configured to compress the bathing aid. In one embodiment, at least one of the first shell and the second shell further comprises a plurality of pressure pylons, the pressure pylons being configured to apply pressure to the bathing aid when the enclosure is in a closed configuration.

In one embodiment, at least one of the plurality of pressure pylons is a flat-head pressure pylon. In one embodiment, at least one of the plurality of pressure pylons is a round-head pressure pylon. In one embodiment, the plurality of pressure pylons is arranged in a heterogeneous pattern.

In one embodiment, at least one of the first shell and the second shell comprises scented plastic. In one embodiment, at least one of the first shell and the second shell comprises sanitary plastic.

In one embodiment, the device further comprises a logo space. In one embodiment, the device further comprises a coupling strap. In one embodiment, the device further comprises a warming module. In one embodiment, the device further comprises a supplemental slot.

In one embodiment, at least one of the first shell and the second shell further comprises a compression section configured to receive force from a user and to apply received force to compress the bathing aid when the enclosure is in a closed configuration.

In one embodiment, the device further comprises a third shell. In one embodiment, the first shell defines a first section of the drain hole, the second shell defines a second section of the drain hole, and the third shell defines a third section of the drain hole.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a bathing aid storage device in accordance with one embodiment;

FIG. 2 illustrates a bathing aid storage device in an open configuration in accordance with one embodiment;

FIG. 3 illustrates a cutaway view of a bathing aid storage device in a closed configuration in accordance with one embodiment;

FIG. 4a illustrates a view of a gulley of a bathing aid storage device in accordance with one embodiment; FIG. 4b illustrates a side view of one shell of a bathing aid storage device in accordance with one embodiment;

FIG. 5 illustrates a bathing aid storage device in a closed configuration in accordance with one embodiment;

FIG. 6 illustrates a cutaway view of a bathing aid storage device in an open configuration in accordance with one embodiment;

FIG. 7 illustrates a top view of a shell of a bathing aid storage device in accordance with one embodiment;

FIG. 8a illustrates a side view of a warming module of a bathing aid storage device in accordance with one embodiment; FIG. 8b illustrates a top view of a warming module of a bathing aid storage device in accordance with one embodiment; and

FIG. 9 illustrates an end view of a three-shell-type bathing aid storage device in accordance with one embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. As used herein, a plurality means “one or more.”

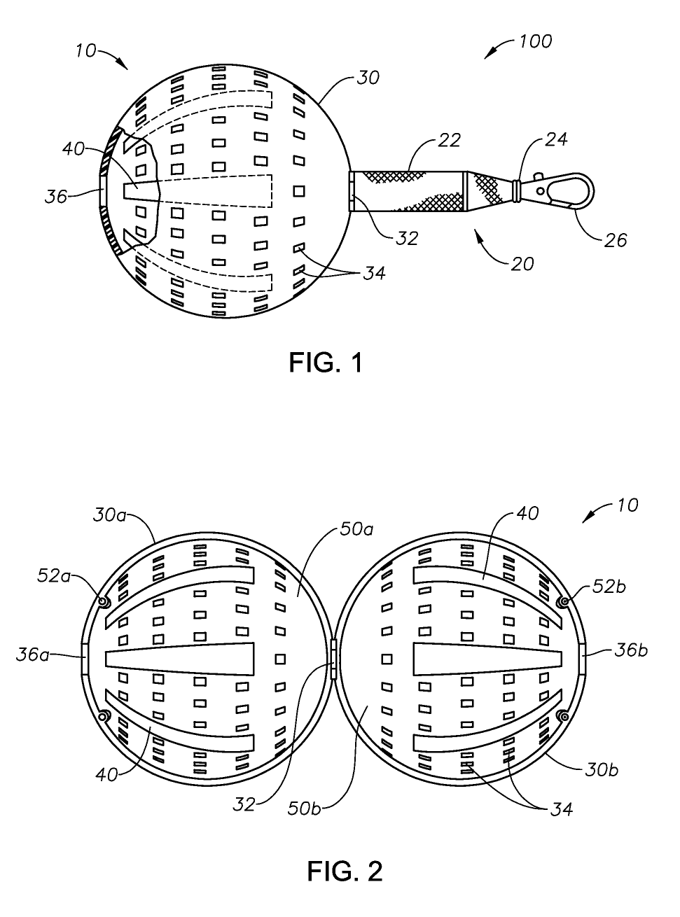

Referring now to the drawings, FIG. 1 illustrates a bathing aid storage device in accordance with one embodiment. Specifically, FIG. 1 shows a bathing aid storage device 100, in accordance with a preferred embodiment of the present invention.

Very generally, in the illustrated embodiment, device 100 is a hygienic device configured as a storage and travel case for a bathing aid. Generally, the embodiments described herein will be discussed with respect to a synthetic loofah bathing aid. One skilled in the art will understand that the embodiments disclosed herein can be adapted for any number of other types of bathing aids.

In the illustrated embodiment, device 100 is generally configured to receive and store a bathing aid in a manner so as to facilitate removal of residual moisture in the bathing aid while also reducing the incidence of mildew, mold, odor, bacteria, and/or other undesirable conditions. In the illustrated embodiment, device 100 is also, generally, configured to couple to a gym bag or back pack, among other things, and provides a clean, hygienic place to put a just-used loofah, while still wet or damp, in a convenient protective case, readily attachable to any style of bag, that encourages the loofah to dry and discourages mildew, etc., so that the loofah remains clean and fresh for its next use.

In the illustrated embodiment, device 100 includes an orb 10. In the illustrated embodiment, orb 10 is an orb. In an alternate embodiment, orb 10 is a sphere, bulging sphere, ovoid, pyramid, round cylinder, square cylinder, clamshell, or any other suitable shape. For ease of explanation, orb 10 is illustrated in a substantially spherical shape. In a preferred embodiment, the optimal aeration and drainage shape for orb 10 is approximately spherical.

In one embodiment, orb 10 is constructed from plastic or any other synthetic or semi-synthetic, malleable solid, such as polyethylene, PVC, nylon, etc. One skilled in the art will understand that orb 10 need not be constructed from any particular kind of plastic, although certain plastics will serve better than others, depending on the expected operating environment. Orb 10 can also be constructed from wood, especially scented wood, metal, or other materials, but the preferred embodiment is plastic. In one embodiment orb 10 can be constructed from materials designed to assist liquid or moisture in moving along (and out of) the enclosure. In one embodiment, orb 10 includes a coating designed to assist liquid or moisture in moving along (and out of) the enclosure.

In one embodiment, orb 10 is constructed from scented plastic. In one embodiment, “scented plastic” means plastic that gives off an odor—in a preferred embodiment, the scented plastic gives off an odor by design. In a preferred embodiment, the odor is pleasant, or generally considered to be pleasant. In some embodiments, the odor is configured to encourage a particular emotional state (e.g., calm, happy, energized, etc.). In some embodiments, the odor is configured to accent the sanitary functions associated with the plastic.

In one embodiment, orb 10 is constructed from sanitary plastic. In one embodiment, “sanitary plastic” means anti-bacterial, anti-fungal, or other plastic designed to improve the hygiene of the device, for example, by inhibiting fungal growth, killing bacteria, etc. In one embodiment, “sanitary plastic” also means a material selected for its sanitary characteristics, which includes hypo-allergenic metals, selected woods, etc. This usage of the term “sanitary plastic” to include non-plastic materials is intended to emphasize the sanitary nature of the construction materials, and is therefore not limited to materials strictly meeting the definition of “plastic” as it is generally used. Additionally, in one embodiment, sanitary plastic includes scented plastic and scented plastic includes sanitary plastic. That is, in one embodiment, orb 10 can be constructed from both sanitary plastic and scented plastic.

One skilled in the art will appreciate that orb 10 can be constructed from materials of any color. Generally, orb 10 can be configured with specific colors or patterns, such as, for example, a sports team's colors, school colors, brand-associated coloring, etc. Generally, while the particular colors or patterns displayed on or by orb 10 are typically merely ornamental in nature, in one embodiment, the fact that orb 10 can be configured with such ornamental designs is itself a feature of orb 10.

Generally, orb 10 is configured to receive and contain a bathing aid within an internal enclosure, as described in more detail below. Generally, a bathing aid is a loofah, washcloth, or other suitable device used by a user to wash the user's body or other cleaning target. In the illustrated embodiment, orb 10 includes an outer surface 30, a hinge 32, a plurality of apertures 34, a drain hole 36, and a plurality of gullies 40.

Generally, in the illustrated embodiment, outer surface 30 surrounds an enclosure, visible in part by virtue of the cutaway section shown in FIG. 1. As described in more detail below, the enclosure is configured to receive and store a bathing aid. In the illustrated embodiment, outer surface 30 spans two segments of orb 10, coupled together by hinge 32. In an alternate embodiment, described in more detail below, outer surface 30 spans more than two segments of orb 10.

In the illustrated embodiment, hinge 32 is an otherwise conventional hinge. In the illustrated embodiment, hinge 32 is configured to couple two (or more) segments of orb 10 together, in order to facilitate opening and closing the orb. In an alternate embodiment, hinge 32 can be omitted and orb 10 can be configured with two half-orbs that screw or snap together, for example.

In the illustrated embodiment, orb 10 also includes apertures 34. Apertures 34 are generally configured to permit airflow into and out of the enclosure formed by orb 10. One skilled in the art will appreciate that airflow in, through, and out of the enclosure facilitates removal of moisture from within orb 10. In particular, improved airflow improves the drying time of a bathing aid enclosed within orb 10.

In the illustrated embodiment, apertures 34 are configured as passages through surface 30 and into the enclosure formed by orb 10, coupling the atmosphere within orb 10 (the internal atmosphere) with the outside atmosphere. In the illustrated embodiment, each aperture 34 connects the internal atmosphere with the outside atmosphere.

In an alternate embodiment, one or more apertures can be joined on one side of surface 30 to form a collection of channels. In one embodiment, the channels follow a path along surface 30 and/or through the material of orb 10. In a preferred embodiment, the channels are substantially normal to the surface 30 (at the point of the aperture 34), forming the shortest connection between the inside atmosphere and outside atmosphere.

In the illustrated embodiment, apertures 34 are generally rectangular and/or trapezoidal, varying in size and shape based on their location on surface 30. In an alternate embodiment, apertures 34 are oval and/or circular. In one embodiment, apertures 34 are substantially uniform in size.

In the illustrated embodiment, orb 10 also includes drain hole 36. Generally, drain hole 36 is an aperture configured to permit relatively easy flow of liquid out of the enclosure formed by orb 10. In one embodiment, drain hole 36 is a simple hole or aperture. In an alternate embodiment, drain hole 36 can be configured with a screen or mesh in order to reduce passage of debris into or out of orb 10.

In the illustrated embodiment, drain hole 36 is formed in part from each of two halves of orb 10. In an alternate embodiment, drain hole 36 can be located entirely on one or the other of two halves of orb 10. In embodiments with multiple orb segments, drain hole 36 can be located in part on each orb segment, or on less than all of the multiple shell segments. For example, in one alternate embodiment, drain hole 36 can be located in two of three total orb segments. In another alternate embodiment, drain hole 36 can be located on only one of three total orb segments. Additionally, in alternate embodiments, drain hole 36 can be positioned to be equally or unequally distributed among the total orb segments.

In the illustrated embodiment, drain hole 36 is located approximately at the point on orb 10 opposite the hinge 32. In one embodiment, drain hole 36 is located at the lowest point (the point most hanging down) when the strap 20 is connected to something and device 100 is allowed to align with the Earth's gravity. In an alternate embodiment, drain hole 36 can be configured on the “side” of the orb, that is, on a point somewhere between the lowest point and the point where strap 20 couples to orb 10.

In the illustrated embodiment, orb 10 is shown with only one drain hole 36. In an alternate embodiment, orb 10 can be configured with multiple drain holes 36.

In the illustrated embodiment, drain hole 36 is shown as a substantially circular hole. In an alternate embodiment, drain hole 36 can be configured as a rectangular hole, triangular hole, or other suitable shape. Similarly, in the illustrated embodiment, drain hole 36 is shown as a substantially larger aperture than an aperture 34. Generally, in a preferred embodiment, drain hole 36 is substantially larger than an aperture 34. In one embodiment, drain hole 36 is at least twice the size of the average aperture 34. In an alternate embodiment, one or more of apertures 34 can serve as a drain hole 36. In an alternate embodiment, orb 10 can be configured without an identified drain hole 36, with the plurality of apertures 34 collective (or individually) serving as an egress for collected liquid inside orb 10.

In the illustrated embodiment, orb 10 includes one or more gullies 40. Generally, gullies 40 are indentations cut into the surface of orb 10 opposite surface 30, as described in more detail below. Generally, gullies 40 serve to direct liquid along the inner surface of orb 10 towards drain hole 36. In an alternate embodiment, one or more gullies 40 are configured to direct liquid to one or more apertures 34 in addition to, or instead of, drain hole 36.

In the illustrated embodiment, device 100 includes an orb 10 coupled to a strap 20. In an alternate embodiment, device 100 does not include strap 20. In the illustrated embodiment, strap 20 couples to orb 10 at hinge 32. In an alternate embodiment, strap 20 couples to orb 10 at a point other than at hinge 32.

In the illustrated embodiment, strap 20 includes an extension 22. In one embodiment, extension 22 an elongated strip of nylon or other durable material. In one embodiment, extension 22 can be configured as a rope, cord, etc. In one embodiment, extension 22 can be constructed from leather, cotton, natural or synthetic material, etc. Generally, in one embodiment, extension 22 serves to provide length to strap 20, so that device 100 can be more conveniently coupled to a retaining point.

In the illustrated embodiment, extension 22 couples to a coupler 24. In one embodiment, coupler 24 is generally configured to connect extension 22 to a connector 26. In one embodiment, coupler 24 is a rotatable coupler, configured to allow connector 26 to assume various orientations with respect to extension 22. In one embodiment, coupler 24 is an otherwise conventional connection between a strap and an end-connector. In one embodiment, coupler 24 is configured to allow ease of movement of a connected connector 26.

In the illustrated embodiment, coupler 24 couples extension 22 to a connector 26. In an alternate embodiment, coupler 24 can be omitted or subsumed into connector 26, wherein extension 22 couples directly to connector 26. In the illustrated embodiment connector 26 is a clip. In an alternate embodiment, connector 26 can be configured as a hoop and toggle, a hook, a clasp, a Velcro strip, or other suitable device to fasten to a gym bag, etc. In one embodiment, connector 26 is configured for easy attachment or detachment.

In the illustrated embodiment, strap 20 includes both a coupler 24 and a connector 26. In an alternate embodiment, strap 20 can be configured without either a coupler 24 or a connector 26. For example, in an embodiment where extension 22 terminates in a loop, the user can use the loop to attach the loofah holder to a target attachment point.

In one embodiment, orb 10 is a one-segment hollow orb and drain hole 36 is configured to be large enough for a user to be able to push through a standard-sized loofah, but small enough to prevent the loofah from falling out of the enclosure unintentionally. In this embodiment, the orb 10 can be constructed from segments and fused into a single final shape. Generally, in this embodiment, the user stuffs the loofah into orb 10 through the drain hole 36, which compresses the loofah as the loofah passes through drain hole 36. Similarly, the user can remove the loofah by pulling it out of the enclosure through the drain hole 36. Generally, the drain hole 36 of a one-segment embodiment can be configured much larger than that of a multi-segment embodiment, in order to facilitate the user inserting fingers into the enclosure to grab the loofah. One skilled in the art will appreciate that single-segment embodiments can be configured without a hinge 32, for example.

FIG. 2 shows an exemplary multi-segment embodiment. Generally, FIG. 2 illustrates a bathing aid storage device in an open configuration in accordance with one embodiment, revealing the enclosure within. In the illustrated embodiment, orb 10 includes segments (two half-shells 50a and 50b) coupled together by hinge 32. In the illustrated embodiment, shells 50a and 50b together form the overall spherical shape of orb 10. In an alternate embodiment, orb 10 can also be configured with more than two segments.

In the illustrated embodiment, surface 30 is distributed between shells 50a and 50b as surface 30a and surface 30b, respectively. In the illustrated embodiment, each of shells 50a and 50b include a plurality of apertures 34 and gullies 40 distributed approximately equally between shell 50a and shell 50b. In alternate embodiments, apertures 34 and gullies 40 are distributed unequally between shell 50a and shell 50b.

In the illustrated embodiment, each of shells 50a and 50b include three gullies 40. In an alternate embodiment, gullies 40 can be omitted. In an alternate embodiment, only one of shell 50a and 50b can be configured with a gully 40. One skilled in the art will appreciate that the number, arrangement, and particular configuration of the gullies 40 can be modified based on a variety of factors including, for example, the thickness of shells 50a and 50b, the arrangement or pattern of apertures 34, the visual impression presented by the gullies 40, and other suitable factors.

In the illustrated embodiment, drain hole 36 is also distributed between shells 50a and 50b as drain hole 36a and drain hole 36b, respectively. In the illustrated embodiment, drain hole 36a and drain hole 36b are configured as semicircular notches cut into surfaces 30a and 30b, such that when the shells 50a and 50b are moved into a closed orientation, drain holes 36a and 36b align to form an approximately circular drain hole 36. In an alternate embodiment, one or more of drain holes 36a and 36b can be configured as a circular, square, or other shaped-drain hole, with or without consideration of the relative positions of drain holes 36a and/or 36b when orb 10 is in the closed orientation.

That is, drain holes 36, 36a, and 36b are shown in the illustrated embodiment in a circular configuration. In alternate embodiments, drain hole 36 can be configured in any desired shape, such as a cowboy hat or mascot silhouette, for example, with drain holes 36a and 36b each forming a part of the desired complete shape.

Additionally, in the illustrated embodiment, drain holes 36a and 36b are located at a position approximately opposite that of hinge 32. As described in more detail above, in alternate embodiments, drain holes 36a and 36b can be configured in other relative orientations with respect to each other as well as hinge 32. In one embodiment, drain holes 36a and 36b are configured so as to align at a low point on orb 10 when orb 10 is attached to another object.

In the illustrated embodiment, orb 10 also includes fasteners configured to secure shells 50a and 50b to each other when orb 10 is in the closed configuration. In the illustrated embodiment, female fastener 52a is configured to receive male fastener 52b. In the illustrated embodiment, fasteners 52a and 52b together operate to keep shells 50a and 50b in the closed configuration absent user force to separate the shells. In the illustrated embodiment, orb 10 is shown with two pairs of male/female fasteners. One skilled in the art will appreciate that other fastener types and configurations can also be employed.

One skilled in the art will appreciate that compressing a loofah can encourage the removal of moisture. In one embodiment, shells 50a and 50b are configured to form an enclosure of a size slightly smaller than that of a standard loofah. In one embodiment, the enclosure is small enough to compress the loofah, while still allowing the loofah to expand within the enclosure, improving the surface area exposed to ventilation. In one embodiment, shells 50a and 50b are configured to compress a loofah when the loofah is placed in the enclosure. In one embodiment, described in more detail below, orb 10 includes additional structures configured to apply pressure to an enclosed loofah.

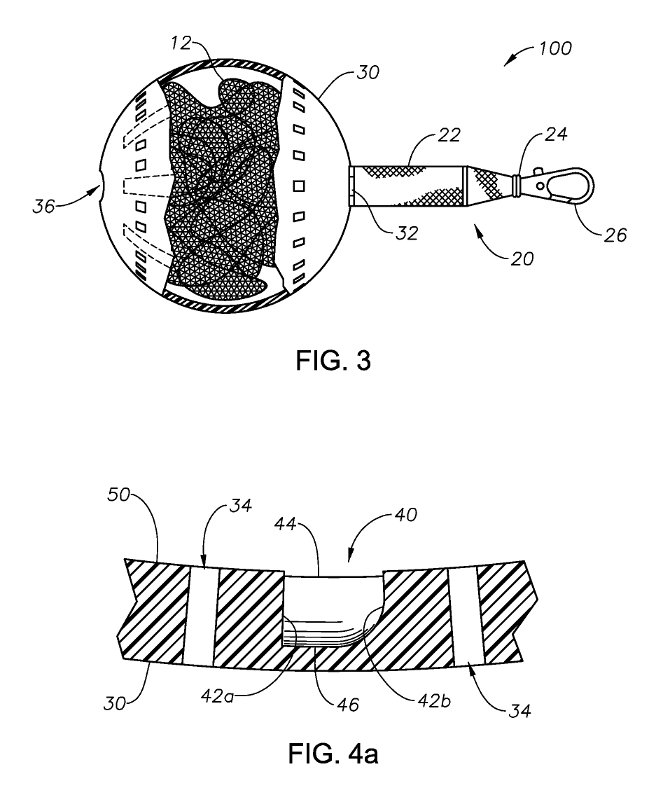

FIG. 3 illustrates a cutaway view of a bathing aid storage device in a closed configuration in accordance with one embodiment. Specifically, device 100 is shown with part of orb 10/surface 30 in cutaway view, providing a view of an enclosed bathing aid 12. As shown in the illustrated embodiment, bathing aid 12 has expanded somewhat inside the enclosure. One skilled in the art will appreciate that the size of the enclosure can be designed based on the expected size of the bathing aid stored in device 100.

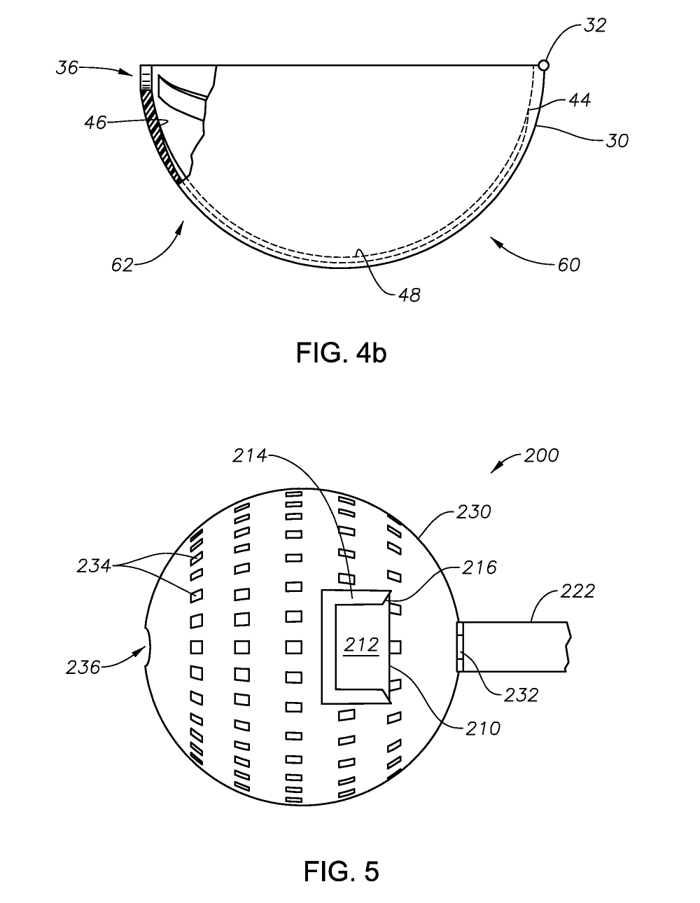

FIG. 4a illustrates a view of a gulley of a bathing aid storage device in accordance with one embodiment. In particular, FIG. 4a shows a transection of orb 10, looking along the length of a gully 40. Also visible are exemplary apertures 34, shown in a configuration that passes substantially straight through shell 50. Generally, gulley 40 is configured to collect moisture and/or condensation and to help guide collected moisture towards an egress, especially a drain hole, to facilitate moisture removal.

In the illustrated embodiment, gulley 40 is shown with a variety of features. For example, in the illustrated embodiment, gully 40 includes both a straight sidewall 42a and a curved sidewall 42b. In some embodiments, both sides are configured with the same sidewall, either straight sidewall 42a or curved sidewall 42b. One skilled in the art will appreciate that other sidewall configurations can also be employed, including irregular patterns.

In the illustrated embodiment, gulley 40 is shown with a variable depth. In the illustrated embodiment, one end of gulley 40, start point 44, is shallow. That is, the distance from the surface of shell 50 (the inner surface of the enclosure) to the bottom of gulley 40 (towards surface 30) is the shallowest point in the illustrated gulley 40.

In the illustrated embodiment, gulley 40 becomes deeper as it passes along shell 50 towards the drain hole (not shown). In the illustrated embodiment, gulley 40 is deepest at end point 46, which in the illustrated embodiment is also the point closest to the drain hole. One skilled in the art will appreciate that other configurations can also be employed. For example, in one embodiment, start point 44 and the end of gulley 40 closest to the drain hole are both relatively shallow, and the deepest point of gulley 40 is close to the midpoint between start point 44 and the end of gulley 40 closest to the drain hole. Generally, the particular arrangement of depths along gulley 40 can be configured based on the expected orientation for orb 10 when orb 10 encloses a bathing aid is coupled to a gym bag, for example.

FIG. 4b illustrates a side view of one shell of a bathing aid storage device in accordance with one embodiment. In the illustrated embodiment, the surface 30 couples to a hinge 32 and includes a drain hole 36. In the illustrated embodiment, drain hole 36 is shown as a partial section of a drain hole 36, as described above.

In the illustrated embodiment, area 60 is relatively far from drain hole 36 and area 62 is relatively close to drain hole 36. As shown in the illustrated embodiment, gully 40 is configured with different depths, indicated by line 48. In one embodiment, the depth of gulley 40 is substantially constant, except near the end points (point 44 and point 46) of gulley 40.

In the illustrated embodiment, point 44 is the terminus of the gully opposite drain hole 36, where the depth of the gully reaches zero. Similarly, in the illustrated embodiment, point 46 is the terminus of the gully nearest drain hole 36, where the depth of the gully also reaches zero.

Generally, the gullies can be configured to collect and direct moisture as it is removed from the bathing aid, and direct it towards the drain hole. In one embodiment, one or more gullies can be configured based only on the expected orientation of the orb when it is hanging down, or dynamically as the orb is jostled in use. In one embodiment, one or more gullies can be coupled to one or more apertures, in addition to or in lieu of directing collected moisture towards a drain hole. One skilled in the art will understand that other configurations can be employed.

FIG. 5 illustrates a bathing aid storage device in a closed configuration in accordance with one embodiment. In particular, in the illustrated embodiment, a bathing aid storage device 200 includes a surface 230. In the illustrated embodiment, surface 230 includes a plurality of apertures 234 and a drain hole 236.

In the illustrated embodiment, device 200 also includes a hinge 232 coupled to a strap 222. Generally, in one embodiment, surface 230, apertures 234, drain hole 236, hinge 232, and strap 222 are configured as described above with respect to surface 30, apertures 34, drain hole 36, hinge 32, and strap 22, respectively, of FIG. 1.

In the illustrated embodiment, device 200 also includes a logo space 210. Generally, in the illustrated embodiment, logo space 210 is a section or component of device 200 for a symbol, logo, advertisement, name plate, etc. In one embodiment, logo space 210 is a separate component attached to surface 230 by affixing to surface 230 and/or through one or more apertures 234. In one embodiment, logo space 210 is a section of surface 230 in which no apertures 234 or drain holes 36 are present. In one embodiment, logo space 230 is a place on surface 230 wherein the device 200 manufacturer can place symbols, information, etc., so that the logo can be viewed by a user/others.

In the illustrated embodiment, logo space 210 includes a base plate 212 and a retaining lip 214. Generally, base plate 212 can be constructed from any suitable material. In the illustrated embodiment, base plate 212 is configured in a substantially rectangular shape. In alternate embodiments, base plate 212 can be configured is a substantially square, triangular, round, octagonal, or other suitable shape.

In the illustrated embodiment, base plate 212 couples to a retaining lip 214. In an alternate embodiment, logo space 210 does not include a separate base plate 212 and retaining lip 214 couples directly to shell 230. In an alternate embodiment, device 200 does not include a retaining lip 214. In one such embodiment, a logo or other desired information is printed on base plate 212. Generally, retaining lip 214 can be constructed from any suitable material, and in one embodiment is constructed from the same material as base plate 212.

Generally, retaining lip 214 is configured to receive and retain an insert. In the illustrated embodiment, retaining lip 214 is configured to overlap with approximately three-quarters of the substantially rectangular base plate 212. That is, in the illustrated embodiment, retaining lip 214 is configured to overlap over substantially three of four edges of the substantially rectangular base plate 212. In one embodiment, retaining lip 214 is configured to overlap along substantially the entire circumference of base plate 212.

In one embodiment, retaining lip 214 is configured to follow the circumference of a non-rectangular base plate 212. For example, in one embodiment, retaining lip 214 is configured to follow the circumference of a pentagonal base plate 212. In one embodiment, retaining lip 214 is configured to overlap over substantially four of five edges of a substantially rectangular base plate 212.

In the illustrated embodiment, retaining lip 214 is configured as a single contiguous lip. In one embodiment, retaining lip 214 includes one or more gaps. In the illustrated embodiment, retaining lip 214 is a separate component coupled to base plate 212. In one embodiment, retaining lip 214 is formed from base plate 212, for example, by folding up three of the four edges of base plate 212.

As described above, retaining lip 214 is configured to receive and retain an insert. In one embodiment, the insert is a name plate or business card, for example. In one embodiment, the insert is a scented insert, configured to emit a scent. In one embodiment, the insert is a paper card with a logo or name printed on the paper card. In one embodiment, the insert is paper or coin money, for example, to serve as emergency money.

In one embodiment, the insert is a fragrance element. For example, in one embodiment, the insert is a commercially available insert ordinarily used in plug-in air fresheners or automobile air fresheners. In one embodiment, the insert is a fragrance element configured to emit a scent when subjected to heat produced by a warming element, for example. Additional information regarding a warming element is provided below.

In one embodiment, logo space 210 includes a compression point. In one embodiment, a compression point is a portion of shell 230 at which a use can apply pressure, the result of which is to squeeze the enclosed bathing aid, assisting in removing moisture from the bathing aid. One skilled in the art will appreciate that the compression “point” can be substantially larger than a single point. Thus, in many embodiments, the compression point is an area of shell 230.

In one embodiment, the compression point aligns with one or more pressure pylons, described in more detail below. In one embodiment, the compression point is a portion of shell 230 wherein the thickness is somewhat smaller than the thickness of the area surrounding the portion of shell 230. In one embodiment, the thickness of shell 230 at the compression point is at least thick enough to prevent the user's applied pressure from penetrating through shell 230.

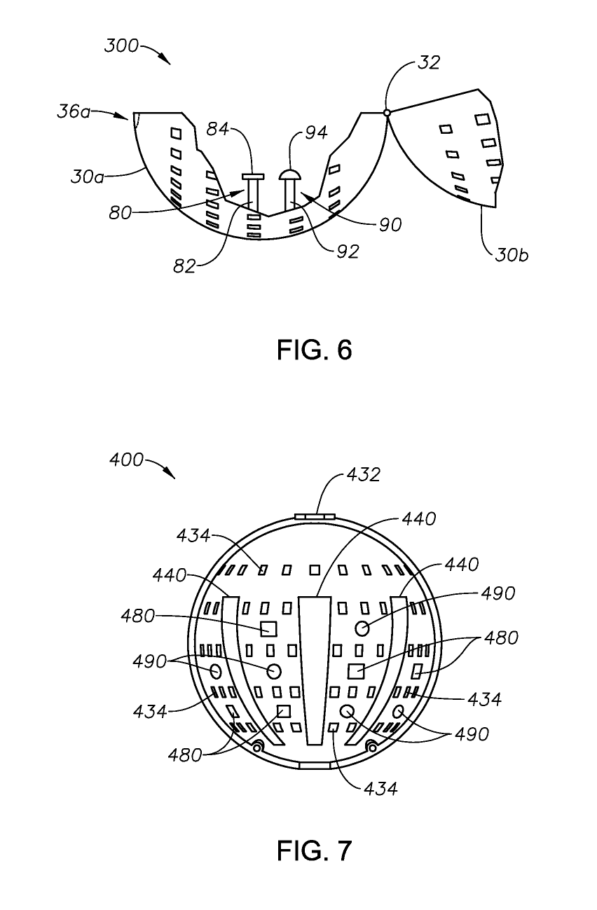

FIGS. 6 and 7 illustrate bathing aid storage devices that include exemplary pressure pylons. FIG. 6 illustrates a cutaway view of a bathing aid storage device in an open configuration in accordance with one embodiment. Specifically, FIG. 6 shows a bathing aid storage device 300, in cutaway view, configured with two types of pressure pylons.

In the illustrated embodiment, device 300 includes a first shell 30a coupled to a second shell 30b (partially illustrated) by a hinge 32. In the illustrated embodiment, a portion of a drain hole 36a is also visible. Shell 30a is shown in cutaway view in order to reveal two pressure pylons within, pressure pylon 80 and pressure pylon 90. In the illustrated embodiment, only two pressure pylons (80 and 90) are shown. One skilled in the art will appreciate that any number of pressure pylons can also be employed.

In the illustrated embodiment, pressure pylons 80 and 90 are, generally, configured to apply pressure to a bathing aid stored within the enclosure formed by device 300 when shells 30a and 30b are in the closed configuration. Generally, the pressure applied by pressure pylons 80 and 90, in one embodiment, is the result of the bathing aid pressing against the pylons. In one embodiment, the pressure is the result of one set of pressure pylons pushing the bathing aid against pressure pylons on the opposite side of the enclosure. In one embodiment, the pressure is the result of a user applying pressure to the bathing aid, pressing the bathing aid against the pylons, when the device is in the open configuration.

As described above, in the illustrated embodiment, device 300 includes two types of pressure pylons, pressure pylon 80 and pressure pylon 90. Generally, in the illustrated embodiment, each type of pressure pylon comprises an elongated member (or “shaft”) and a head. In the illustrated embodiment, pressure pylon 80 includes a shaft 82 and a head 84. In the illustrated embodiment, head 84 is configured as a substantially flat surface, formed as a rectangular plate. Similarly, in the illustrated embodiment, pressure pylon 90 includes a shaft 92 and a head 94. In the illustrated embodiment, head 94 is configured as a substantially circular, rounded head. One skilled in the art will appreciate that the selection of head configuration can be designed to apply pressure without catching on the fabric of the bathing aid, where such catching would make the bathing aid more difficult to remove from the device and/or damage the bathing aid. One skilled in the art will also understand that the head configuration can be selected based on the expected bathing aid to be used with the device. For example, in cases where the bathing aid includes numerous small holes, a circular profile that will not catch on the strands of fabric of the bathing aid is preferred.

Generally, shafts 82 and 92 can be configured at any suitable length, including variable lengths in the same device. In one embodiment, the length is selected to optimize pressure against the bathing aid. In another embodiment, the length is selected to optimize manufacturing costs. One skilled in the art will appreciate that other optimization factors can also be employed.

In the illustrated embodiment, pressure pylons 80 and 90 are constructed from the same material as shell 30a. In one embodiment, one or more of pressure pylons 80 or 90 can be separately manufactured and subsequently affixed to the inside of shell 30a. In one embodiment, one or more of pressure pylons 80 or 90 can be manufactured in one piece with shell 30a, as part of the process to manufacture shell 30a.

In the illustrated embodiment, device 300 is shown with pressure pylons 80 and 90 arranged side by side. In one embodiment, device 300 comprises only pressure pylons of a single type. In one embodiment, device 300 comprises pressure pylons 80 and 90 (or otherwise of different types) arranged in a pattern.

For example, FIG. 7 illustrates a top view of a shell of a bathing aid storage device in accordance with one embodiment. In the illustrated embodiment, device 400 includes a first shell coupled to a second shell (not shown) by a hinge 432. In the illustrated embodiment, a portion of a drain hole is also visible. Device 400 is shown in an open configuration to reveal the pattern of gullies, apertures, and pressure pylons therein.

In the illustrated embodiment, device 400 includes a plurality of apertures 434 arranged around a plurality of gullies 440. In addition, in the illustrated embodiment, device 400 includes a plurality of pressure pylons 480 and 490. For ease of illustration, pressure pylon 480 is shown as a circle and pressure pylon 490 is shown as a square. In one embodiment, pressure pylon 480 corresponds to pressure pylon 80 and pressure pylon 490 corresponds to pressure pylon 90.

In the illustrated embodiment, pressure pylons 480 and 490 are disposed in locations not otherwise occupied by apertures or gullies. As shown in the illustrated embodiment, pressure pylons 480 and 490 can be arranged in an alternating pattern. In one embodiment, a pressure pylon 480 is located on one shell of device 400 to align with a pressure pylon 490 located on the other shell of device 400 (in a two-shell embodiment). Similarly in one embodiment, a pressure pylon 490 is located on one shell of device 400 to align with a pressure pylon 480 located on the other shell of device 400. In one embodiment, pressure pylons 480 and/or 490 are disposed on one shell so as to be unaligned with a pressure pylon located on the other shell (in a two-shell embodiment). In one embodiment, a pressure pylon 480 and/or 490 is disposed on the shell near or within a compression point, configured to press into an enclosed bathing aid in response to user pressure on the compression point. One skilled in the art will appreciate that a variety of patterns for pressure pylons 480 and/or 490 can be employed.

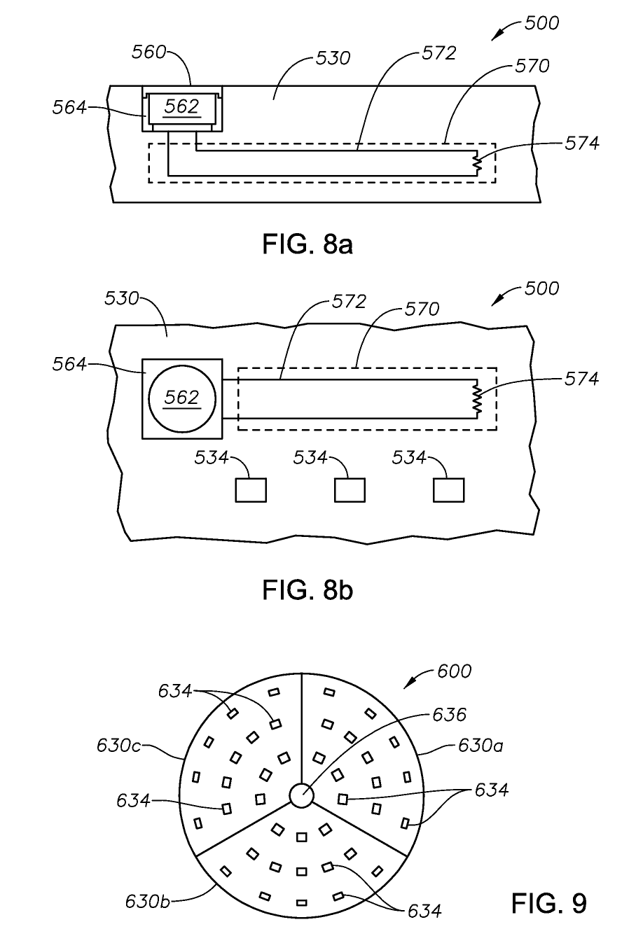

FIG. 8a illustrates a side view of a warming module of a bathing aid storage device in accordance with one embodiment. In particular, FIG. 8a shows a cutaway view of a device 500, from the side, illustrating various components of a warming module. In one embodiment, device 500 is a bathing aid storage device as otherwise described herein.

In the illustrated embodiment, device 500 includes a surface 530. Generally, in the illustrated embodiment, surface 530 is configured in a similar manner as surface 30 of FIG. 1, for example. In the illustrated embodiment, device 500 also includes cap 560 that covers a battery compartment 564, which in turn contains a battery 562.

In one embodiment, cap 560 is configured to fasten securely to surface 530, or otherwise remain in place covering battery compartment 564, while still being removable by a user, for access to exchange battery 562, for example. In one embodiment, cap 560 includes electric/electrical circuitry, for example, to complete the circuit between the battery 562 and the rest of the warming module. In one embodiment, cap 560 includes a fragrance element configured to emit a fragrance in response to warming of cap 560.

In the illustrated embodiment, battery compartment 564 is an otherwise conventional battery compartment, configured to receive and retain a battery. In one embodiment, battery compartment 564 is configured to accommodate a battery. In an alternate embodiment, battery compartment 564 is configured to accommodate a battery as well as other electrical/electronic components.

Generally, cap 560, battery 562, and battery compartment 564 together form a power module for the warming module. One skilled in the art will appreciate that there are a wide variety of methods and systems for providing portable power to a small electronic/electrical device. For example, in an alternate embodiment, battery 562 is a rechargeable battery and cap 560 includes a photosensitive panel configured to charge battery 562 in response to received light. One skilled in the art will appreciate that other configurations can also be employed.

In the illustrated embodiment, device 500 also includes a warming coil 570. Generally, in the illustrated embodiment, warming coil 570 is configured to receive electrical energy and to convert received electrical energy into heat. In the illustrated embodiment, warming coil 570 includes a wire 572 and a resistive element 574.

In one embodiment, wire 572 is an otherwise conventional copper or other metal wire. In one embodiment, wire 572 is configured to deliver electric current to resistive element 574 without also substantially generating heat. In one embodiment, wire 572 is also configured to generate heat. In one embodiment, resistive element 574 is an otherwise conventional resistor. In one embodiment, resistive element 574 is configured to generate heat in response to receive electrical energy. One skilled in the art will understand that the specifications of wire 572 and resistive element 574 can be configured to generate sufficient heat to warm surface 530 without also causing surface 530 to melt or otherwise deform.

In one embodiment, resistive element 574 is coupled to a fragrance module, providing heat to release the fragrance. In one embodiment, the fragrance module couples to or is part of a logo space. In one embodiment, the fragrance module is configured to receive an otherwise conventional scent package as are readily commercially available. In one embodiment, surface 530 comprises plastic configured to emit a scent when subject to warming.

In the illustrated embodiment, warming coil 570 includes a wire arranged in a single loop. In one embodiment, particularly an embodiment wherein the wire itself generates heat, wire 572 is arranged to travel along a desired path within surface 530. In one embodiment, the desired path is a winding path covering a large portion of surface 530. One skilled in the art will appreciate that there are a variety of suitable patterns that can be employed.

In the illustrated embodiment, warming coil 570 includes a single wire 572 and resistive element 574. In one embodiment, warming coil 570 includes multiple wires 572 and/or resistive elements 574. In one embodiment, multiple wires 572 and/or resistive elements 574 are configured to provide warming heat to a large portion of surface 530. One skilled in the art will appreciate that there are a variety of suitable patterns that can be employed.

In the illustrated embodiment, device 500 includes a single battery 562 powering a single warming coil 570. In one embodiment, a single battery 562 powers multiple warming coils 570. In one embodiment, device 500 includes multiple batteries 562, providing power to one or more warming coils 570.

In the illustrated embodiment, device 500 is shown with a single battery 562 powering a single warming coil 570 for one shell of device 500. In one embodiment, each shell of device 500 includes a battery 562 and an associated warming coil 570. In one embodiment, only one shell of device 500 includes a warming coil 570. In one embodiment, a single battery 562 provides power to a warming coil 570 that spans more than one shell of device 500.

FIG. 8b illustrates a top view of a warming module of a bathing aid storage device in accordance with one embodiment. In the illustrated embodiment, warming coil 570 is shown configured to avoid parts of surface 530 that include apertures 534. In an alternate embodiment, warming coil 570 can be configured to cover parts of surface 530 that include apertures 534.

In the illustrated embodiment of FIGS. 8a and 8b, the warming module is configured to operate in response to user activation, for example, by an on/off switch (not shown). In an alternate embodiment, the warming module couples to a switch configured to place the warming module in an “on” operational state whenever the device 500 is in the closed configuration. In one embodiment, device 500 includes circuitry or other control mechanisms to place the warming module in an “off” operational state after a predetermined amount of time.

In the illustrated embodiment, the warming module is configured to generate heat that warms the surface 530 (or the shell) or a fragrance module. In an alternate embodiment, the warming module can be configured to warm and/or disinfect device 500. One skilled in the art will appreciate that other uses of the generated heat/electricity can also be employed, such as, for example, as a hand-warmer or to power lights, displays, battery monitors, audio-generating devices, etc.

Some of the above embodiments illustrate a two-shell bathing aid storage device. FIG. 9 illustrates an end-view of a three-shell-type bathing aid storage device in accordance with one embodiment. In particular, FIG. 9 illustrates a bathing aid storage device 600 configured with three shells.

In the illustrated embodiment, device 600 includes shell 630a, shell 630b, and shell 630c. In the illustrated embodiment, each of shells 630a-c provide approximately one-third of the overall device surface area. In other embodiments, shells 630a, 630b, and/or 630c can also be configured with dissimilar percentages of the overall device surface area.

Similarly, in the illustrated embodiment, each of shells 630a-c provide approximately one-third of the structure for drain hole 636. In other embodiments, shells 630a, 630b, and/or 630c can also be configured with dissimilar percentages of the structure for drain hole 636. In other embodiments, drain hole 636 can be located less than all of the shells 630a, 630b, and 630c. For example, in one embodiment, drain hole 636 is located on shell 630a only.

Thus, some of the disclosed embodiments provide a hygienic device that is a travel case for a synthetic loofah. In some embodiments, the device can hook or clasp on to a gym bag or back pack, among other things, and provides a clean, hygienic place to put a loofah or other bathing aid when the bathing aid is not in use and in between uses. In some embodiments, the case allows the user to put a recently-used loofah, in a still wet or damp condition, in a clean protective case that permits the loofah to dry and not mildew so that it remains clean and fresh for its next use.

In one embodiment, the device is a plastic orb that opens and closes in a clam shell type fashion. In one embodiment, the orb has ventilation holes that allow the loofah to breath to prevent mildew and “gulleys” that direct the moisture to a drain-hole at the bottom of the orb. In one embodiment, a hook or clasp is on a swivel attached to the orb via a nylon cord so that the orb can be clipped on to a gym bag or backpack and therefore subject to an open-air environment, thereby accelerating the drying process.

In one embodiment, on one side of the clam shell “male” fasteners are disposed around the circumference of the orb, and on the other side “female” fasteners are disposed to align with the male fasteners, which fasten the orb shut when the clam shell is closed. In one embodiment, the orb is small enough to compress the loofah while still letting the loofah expand naturally within the orb and to maximize its surface area exposed to ventilation. In one embodiment, after using a loofah, the user need only squeeze the loofah to get as much initial water out as possible, then place it in the orb and snap it closed, then strap it to the user's gym bag or backpack: or “squeeze, snap and strap”.

In one embodiment, the orb is scented so that it can also be placed inside a gym-bag or backpack (or any other travel bag) and act as an air-freshener, especially when the loofah is dry and/or the orb is empty. In one embodiment, the orb is also intended to ornamental in that it will also be an expression of the user's interest and personhood, for example, by reflecting support of a cause the user deems worthy or sporting team the user supports.

Accordingly, the disclosed embodiments provide numerous advantages over other methods and systems. For example, in one embodiment, the device is meant to be seen, not hidden. In previous systems, cases for dental equipment, for example have generally been designed to be unoffensive if seen, but not generally designed for intentional display.

Additionally, previous systems, such as dental equipment cases, for example, do not include a drainage mechanism that uses gravity to assist in the drying process, such as the gullies and/or drain holes found in some of the disclosed embodiments. As a result of the previous systems lying flat and without drainage, the inside of the previous systems tends to become sticky and grimy. But the embodiments disclosed herein allow drainage and excess particles (such as gas, debris, or liquid) to escape the device.

Further, previous systems were known to generate unpleasant odors after long periods of use, especially without washing the previous system cases. In one embodiment, the device is meant to be sniffed. For example, in one embodiment, if a user were to leave one of the disclosed embodiments it in a car, clipped to the outside of a gym bag, the car would likely smell better as a result. Similarly, in one embodiment, if the user were to put one of the disclosed embodiments inside a gym bag, the gym bag will smell better as a result.

Additionally, previous systems did not include active mechanisms to accelerate drying of the enclosed bathing aid, such as the pressure pillars of some disclosed embodiments. Some previous systems were expressly designed to prevent compression of the enclosed contents, such as denture or other dental equipment cases.

Thus, generally, some of the disclosed embodiments provide a device that is economical, useful, and not presently available. Additionally, some embodiments are environmentally friendly in that the device may reduce the use of plastic bags to contain the bathing aid in between uses. Additionally, in some embodiments, the device can be constructed from recycled plastic.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A bathing aid storage device, comprising:
a drain hole; and
a first shell and a second shell;
at least one of the first shell and the second shell comprising a plurality of apertures;
at least one of the first shell and the second shell comprising a plurality of gullies; and
the first shell and the second shell defining an enclosure, the enclosure being configured to accommodate a bathing aid.

2. The device of claim 1, wherein the first shell defines a first section of the drain hole and the second shell defines a second section of the drain hole.

3. The device of claim 1, further comprising a closing mechanism coupled to the first shell and the second shell.

4. The device of claim 3, wherein the closing mechanism comprises a snap.

5. The device of claim 1, wherein the enclosure further comprises a closed configuration configured to compress the bathing aid.

6. The device of claim 1, wherein at least one of the first shell and the second shell further comprises a plurality of pressure pylons, the pressure pylons being configured to apply pressure to the bathing aid when the enclosure is in a closed configuration.

7. The device of claim 6, wherein at least one of the plurality of pressure pylons is a flat-head pressure pylon.

8. The device of claim 6, wherein at least one of the plurality of pressure pylons is a round-head pressure pylon.

9. The device of claim 6, wherein the plurality of pressure pylons is arranged in a heterogeneous pattern.

10. The device of claim 1, further comprising a supplemental slot.

11. The device of claim 1, wherein at least one of the first shell and the second shell comprises scented plastic.

12. The device of claim 1, wherein at least one of the first shell and the second shell comprises sanitary plastic.

13. The device of claim 1, further comprising a logo space.

14. The device of claim 1, further comprising a coupling strap.

15. The device of claim 1, further comprising a warming module.

16. The device of claim 1, wherein at least one of the first shell and the second shell further comprises a compression section configured to receive force from a user and to apply received force to compress the bathing aid when the enclosure is in a closed configuration.

17. The device of claim 1, further comprising a third shell.

18. The device of claim 17, wherein the first shell defines a first section of the drain hole, the second shell defines a second section of the drain hole, and the third shell defines a third section of the drain hole.
